(19) United States
(12) Patent Application Publication
(10) Pub. No.: US 2008/0308963 A1
(43) Pub. Date: Dec. 18, 2008

(54) Process for Producing a Material

(76) Inventor: George Owen, North Yorkshire (GB)

Correspondence Address: KING & SCHICKLI, PLLC, 247 NORTH BROADWAY, LEXINGTON, KY, 40507, US

(21) Appl. No.: 12/064,346

(22) PCT Filed: Aug. 22, 2006
(86) PCT No.: PCT/GB2006/003116

§ 371 Date: Feb. 21, 2008

(30) Foreign Application Priority Data
Aug. 23, 2005 (GB) 0517233.3

(51) Int. Cl. B09B 3/00; B29B 17/00

(52) U.S. Cl. 264/122; 264/128

(57) ABSTRACT

A process for producing a new material consists of utilising pieces of waste material which are to be discarded from a process of scrapping a product such as a vehicle where the product is passed through a shredding machine (12) which shreds, chops or fragments the product which is to be scrapped into small pieces and after at least part of the re-useable pieces have been recovered, mixing or coating (22) the remaining waste material with an encapsulating material for wholly or partially encapsulating the waste material therein to form a new composite material.

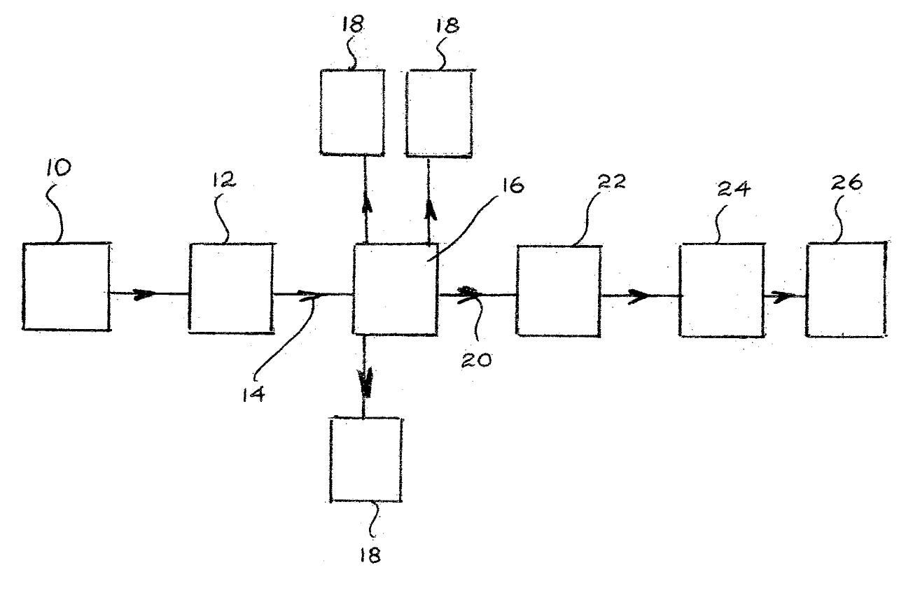

This invention relates to a process for producing a material utilising a waste material as part thereof and more particularly a composite material and the composite material produced by the process.

It is known when a product, including materials having insulation properties, is to be scrapped at the end of its useful life to pass the product through a shredding machine which chops the product into small pieces which are then passed to a discharge point. Sorting means have then been utilised to separate these small pieces into re-useable categories, such as metals, leaving what is regarded as being a non re-useable waste material which has to be disposed of in land-fill sites or incinerated. This disposal of the waste material in land-fill sites suffers from the disadvantage that it is an expensive operation. Furthermore, when the waste material is incinerated it also suffers from the disadvantage that incineration can produce undesirable toxic gases whose cost of filtering and/or absorption from the gaseous products produced by incineration seriously reduces or completely outweighs any cost benefit from the recoverable heat produced by the incineration process.

The object of this invention is to utilise at least part of such material in the process of this invention to produce a new composite material thereby at least partially alleviating the above disadvantages of the above described known scrapping process.

According to one aspect of the invention, a process for producing a new material comprises utilising pieces of waste material which are to be discarded from a process of scrapping a product formed from two or more types of material where the product is passed through a shredding machine which shreds, chops or fragments the product which is to be scrapped into small pieces and at least part of the re-useable pieces have been recovered, mixing or coating the remaining waste material with an encapsulating material for wholly or partially encapsulating the waste material therein to form a new composite material.

Preferably, the encapsulating material is an adhesive or adherent foam material is mixed with the waste material.

Preferably, also, a strengthening material is added during the mixing or coating of the waste material with the encapsulating material.

The strengthening material is of a fibrous form which is, preferably, entrained in a spray of the encapsulating material during the mixing or coating of the waste material.

Preferably, after mixing the encapsulating material with the waste material, the composite material is allowed to cure or set.

Preferably, also, the composite material prior to completion of the curing or setting thereof is moulded, rolled or extruded into a desired form.

The composite material is, preferably, moulded, rolled or extruded into a sheet form.

Preferably, the sheet of composite material prior to or after curing has a sheet of metal foil applied to one or both sides of the sheet to form a panel having insulation properties which is suitable for use in building or the like.

According to another aspect of the invention, a method of scrapping a vehicle to optimise recovery of and recycling of the materials thereof comprises carrying out the process according to any one of the preceding eight paragraphs.

According to a further aspect of the invention, a composite material produced by carrying out the process and/or method in accordance with any one of the preceding nine paragraphs.

A preferred embodiment of the invention will now be described, by way of example only, with reference to the accompanying drawing which is a block diagram of a process for producing a new composite material. Referring now to the drawing, a product 10 such as a vehicle, white goods or any other products in a fully assembled, or partially assembled condition which is formed of two or more types of material at least one of which has insulation properties and which is to be scrapped at the end of its useful life is passed through a shredding machine 12 which shreds, chops or fragments the product into small pieces. These pieces are passed along a conveyor system 14 to a sorting station 16. The sorting station 16 includes sorting means or devices which continuously separates metal pieces from the main stream of the small pieces supplied to the sorting station 16 and continuously discharges the metal pieces to collection points 18. Steel pieces or any other pieces formed of material having magnetic properties are separated by magnetic means which lifts the steel pieces and the pieces formed material having magnetic properties from the main stream of the small pieces passing through the sorting station 16. Where the magnetic means are an electromagnet the pieces collected on the electro-magnet are then removed from the electro-magnetic means by moving part of the electro-magnet to one side of the main stream of small pieces being sorted and switching-off said part of the electromagnet to discharge the pieces therefrom to one of the collection points 18. Alternatively, the magnetic means are a permanent magnet and the pieces collected by the magnet are continuously scraped therefrom and discharged to said one of the collection points 18.

The sorting station 16 also comprises a floatation means to which the main stream of the small pieces remaining to be sorted is supplied and depending upon the specific gravity of the floatation liquid it enables further pieces from the main stream of small pieces to be separated therefrom according to the specific gravity of the further pieces. The further pieces being separated from the main stream of small pieces are removed from the surface of the floatation liquid and discharged to another one of the collection points 18.

The sorting station 16 is also provided with an air flow separation means, the air flow of which is directed over the remaining main stream of small pieces at an angle to the direction of said main stream to remove pieces of low specific gravity to one side of the main stream of small pieces which are discharged to another one of the collection points 18. The remainder of the main stream of small pieces is normally regarded as waste material which is mainly formed of plastics, rubber, glass or the like. In conventional processes, this waste material is discarded and is normally disposed of in land fill sites or incinerated.

This waste material is supplied by additional conveying means 20 to an encapsulating station 22 where material is mixed with a liquid encapsulating material by spraying the encapsulating material onto the waste material or adding the liquid encapsulating material and then mixing the waste material with the encapsulating material so that the waste material is encapsulated in said encapsulating material thereby forming a new composite material. The encapsulating material has adherent properties and can be an adhesive of foaming material such as polyurethane foam, an epoxy resin adhesive, an acrylic adhesive or the like.

The composite material is supplied to a forming station 24 where it is moulded, rolled or extruded into a desired form such as a sheet or block form and then passed to a curing station 26 and allowed to cure. Where the composite material is formed into a sheet, a metal foil is applied to one or both sides of the sheet prior to completion of curing so as to be adhesively connected to the sheet. Alternatively, the metal foil is applied to one or both sides of the sheet after curing is completed and additional adhesive is used to secure the metal foil to the associated side of the sheet.

Such sheets of composite material have useful insulation properties, both thermal and electrical insulation properties and can be used in the construction of buildings or in vehicles such as commercial vehicle bodies, caravans, containers or the like. It has also been found that these sheets of material are of sufficient strength and grain structure so as to be capable of being able to support a fixing device which is secured therein such as a screw or nail. This property of the material will allow the material to be used not only as an insulation material but also for structural supports to which other components can be secured such as panelling, cladding or the like.

In a modification, the strength of the composite material can be increased by entraining in the spray of encapsulating material applied in the encapsulating station 22 fibres of material such as chopped glass fibres, fibres of Kevlar or the like.

In a further modification, the so-called waste material supplied to the encapsulating station 22 can be used as an aggregate with other types of encapsulating material such as cement to form concrete sheets or blocks for use in the construction industry. It is envisaged that such blocks can be used to replace building blocks such as breeze blocks or the like.

Although, this invention is concerned with utilising waste material formed when scrapping various products to increase the percentage of the products which can be usefully, recycled, it is particularly relevant to the scrapping of vehicles so as to enable a greater percentage of the weight of the vehicle capable of being re-cycled.

In addition, it will also be appreciated that when the composite material or products formed therefrom reaches the end of its useful life and is to be scrapped, the composite material when passed through the shredding machine 12 forms small pieces of material which can be used in substantial entirety to again produce the composite material and products formed therefrom as described above.

1-11. (canceled)

12. A process for producing a new material comprising utilising pieces of waste material which are to be discarded from a process of scrapping a product formed from two or more types of material where the product is passed through a shredding machine which shreds, chops or fragments the product which is to be scrapped into small pieces and at least part of the re-usable pieces have been recovered, mixing or coating the pieces of the remaining waste material with an encapsulating material for wholly or partially encapsulating the waste material therein to form a new composite material having properties of strength and grain structure so as to be capable of supporting and having secured therein a fixing device.

13. A process according to claim 12, wherein the composite material is capable of supporting and having secured therein a screw-threaded fixing device.

14. A process according to claim 12, wherein the encapsulating material is an adhesive or adherent foam material which is mixed with the waste material.

15. A process according to claim 12, wherein a strengthening material is added during the mixing or coating of the waste material with the encapsulating material.

16. A process according to claim 15, wherein the strengthening material is of a fibrous form which is entrained in a spray of the encapsulating material during the mixing or coating of the waste material.

17. A process according to claim 12, wherein after mixing the encapsulating material with the waste material, the composite material is allowed to cure or set.

18. A process according to claim 17, wherein the composite material prior to completion of the curing or setting thereof is moulded, rolled or extruded into a desired form.

19. A process according to claim 18, wherein the composite material is moulded, rolled or extruded into a sheet form.

20. A process according to claim 19, wherein the sheet of composite material prior to or after curing has a sheet of metal foil applied to one or both sides to form a panel having insulation properties which is suitable for use in building or the like.

21. A method of scrapping a vehicle to optimise recovery of and recycling of the materials thereof comprising carrying out the process according to claim 12.

22. A composite material produced by carrying out the process according to claim 12.
